(19) United States
(12) Patent Application Publication
(10) Pub. No.: US 2024/0348433 A1
(43) Pub. Date: Oct. 17, 2024

(54) QUANTUM PRIME NUMBER GENERATION (QPNG)

(71) Applicant: Wells Fargo Bank, N.A., San Francisco, CA (US)

(72) Inventor: Jeffrey J. Stapleton, O'Fallon, MO (US)

(73) Assignee: Wells Fargo Bank, N.A., San Francisco, CA (US)

(21) Appl. No.: 18/135,246

(22) Filed: Apr. 17, 2023

(51) Int. Cl. H04L 9/08; G06F 7/58; G06F 7/72; H04L 9/30

(52) U.S. Cl. CPC H04L 9/0869; G06F 7/588; G06F 7/72; H04L 9/3033; G06F 2207/7204

(57) ABSTRACT

The arrangements disclosed herein relate to systems, apparatus, methods, and non-transitory computer readable media for generating, using a Quantum Random Number Generator (QRNG), an initial random number and a secondary random number, generating, using a Prime Number Generator (PGN), a random prime number using the initial random number and the secondary random number, and generating an encryption key using the random prime number, wherein the encryption key is used to encrypt first data or decrypt second data.

### BACKGROUND

Prime numbers are whole numbers divisible only by 1 and itself. Examples of prime numbers include 2, 3, 5, 7, 11, 13, and so on. Prime numbers have applicability within asymmetric cryptography, architecture, acoustic design, and so on. Prime numbers are used with higher mathematics. For example, every number can be encoded as a product of primes, e.g., 8=2³, 25=5², 2197=13³, 529=23² and 232,442,600=2³×5²×13³×23², and so on.

In some examples, asymmetric key generation needs random prime numbers. Random prime number generation needs random numbers. A poor Random Number Generator (RNG) adversely affects the asymmetric key pair. Reusing asymmetric keys, whether intentionally or inadvertently, weakens the effectiveness of any Public Key Infrastructure (PKI) including key management and digital signatures. Predictable or discoverable asymmetric keys may be prone to identity theft, fraud, data breaches, Harvest Now, Decrypt Later (HNDL) attacks, and other issues.

### SUMMARY

The arrangements disclosed herein relate to systems, apparatuses, non-transitory computer-readable media, and methods for generating, using a Quantum Random Number Generator (QRNG), an initial random number and a secondary random number, generating, using a Prime Number Generator (PGN), a random prime number using the initial random number and the secondary random number, and generating an encryption key using the random prime number, wherein the encryption key is used to encrypt first data or decrypt second data.

These and other features, together with the organization and manner of operation thereof, will become apparent from the following detailed description when taken in conjunction with the accompanying drawings.

### BRIEF DESCRIPTION OF THE DRAWINGS

FIG. 1 illustrates an example PNG constructive method using a QRNG for random numbers to generate a random guaranteed prime number, according to some arrangements.

FIG. 2 is a block diagram of an example of a computing system capable of implementing the PNG constructive method shown in FIG. 1, according to some arrangements.

FIG. 3 is a flowchart diagram illustrating an example method for constructing a random prime number, according to some arrangements.

### DETAILED DESCRIPTION

The arrangement described herein relate to systems, methods, non-transitory computer-readable media for Prime Number Generators (PNGs). Prime number generation using a constructive prime number method, which ingests random numbers, can be enhanced with “true” random number from QRNG. For example, Quantum Random Number Generators (QRNGs) can be incorporated with Prime Number Generators (PNGs) using constructive methods to generate random guaranteed prime numbers. In some arrangements, the prime number generation constructive algorithm uses an initial input and additional inputs from the QRNG to recursively build the prime number and outputs a random guaranteed prime number. The “true” randomness of the random number enhances the “true” randomness of the guaranteed prime number.

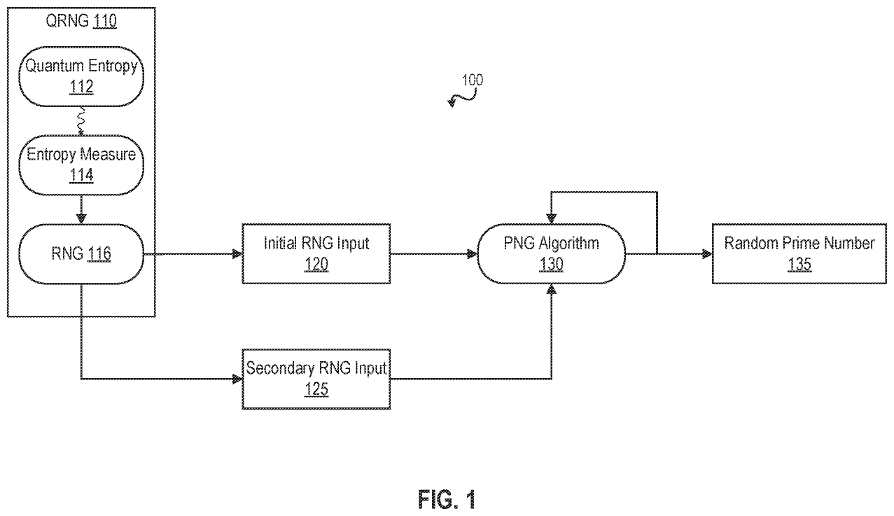

FIG. 1 illustrates an example PNG constructive method 100 using a QRNG 110 for random numbers to generate a random guaranteed prime number (e.g., the random prime number 135), according to various arrangements. The random prime number 135 can be, input into a Key Derivation Function (KDF) to generate a symmetric key, or input to a Key Generation Function (KGF) to generate an asymmetric key. The method 100 incorporates the QRNG 110 for incorporating “true” random numbers with a PNG constructive algorithm to provide random guaranteed prime numbers. Accordingly, the method 100 supports both legacy cryptographic methods (e.g., Rivest-Shamir-Adleman (RSA), Diffie-Hellman, Elliptic-curve cryptography (ECC), and so on) and Post Quantum Cryptography (PQC) algorithms. The method 100 strengthens the effectiveness of the PKI including key management and digital signatures.

The QRNG 110 includes at least a quantum entropy 112, an entropy measure function 114, and a Random Number Generator (RNG) 116. In some examples, the QRNG 110 includes a Quantum Key Distribution (QKD) device. The QRNG 110 can perform an external RNG process using the quantum entropy 112.

The quantum entropy 112 includes one or more quantum entropy sources that can generate a steam of photons containing information such as a string of binary zeroes and ones (e.g., quantum entangled particles or unentangled particles) and sends the stream to computing system implementing the entropy measurement function 114. The quantum entropy sources can generate quantum entangled particles that contain unpredictable information, thus “random.” The quantum entangled particles are measured and interpreted by the entropy measure function 114 to obtain “random bits” which are fed into a RNG algorithm (e.g., the RNG 116) to generate sufficient “random bits.” In some examples, the QRNG 110 can be a remote to a device implementing the PNG algorithm 130 and can provide the RNG inputs 120 and 125 via a network. In some examples, the QRNG 110 can be a device operatively coupled or physically connected to the device implementing the QRNG 110. In some examples, the QRNG 110 and the device implementing the PNG algorithm 130 can be located in a same device (e.g., a same network node).

In some examples, the PNG algorithm 130 includes a constructive method for generating prime numbers. A constructive method for generating prime numbers constructs integers from smaller integers such that the constructed integer is guaranteed to be prime. Examples of the constructive method include Shawe-Taylor's Algorithm, Maurer's Algorithm, and so on. In some examples, the PNG algorithm 130 uses an initial input (e.g., the initial RNG input 120) from the QRNG 110 to recursively build the prime number (e.g., the random prime number 135) using additional RNG inputs (e.g., the secondary RNG input 125) and outputs a guaranteed prime number (e.g., the random prime number 135). Given that, the randomness of the random prime number 135 is based on the randomness of the RNG inputs 120 and 125, improvement randomness of the RNG inputs 120 and 125 can improve the randomness of the random prime number 135.

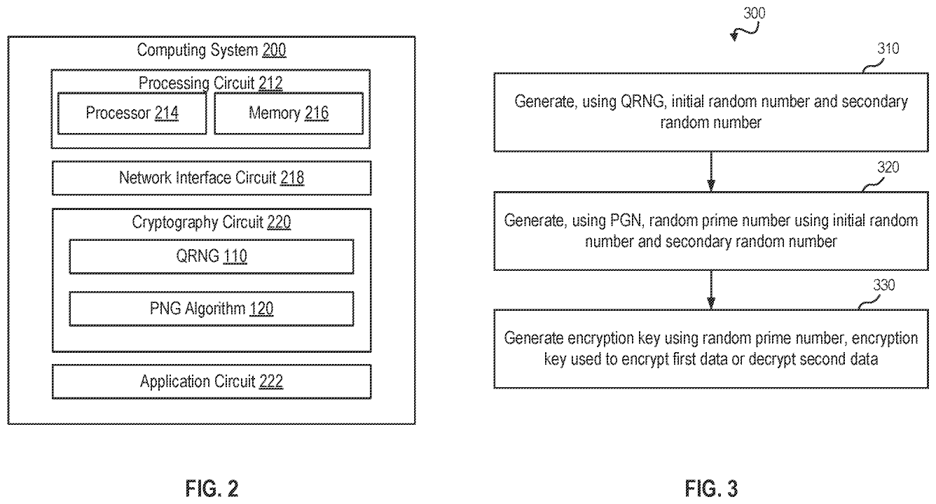

FIG. 2 is a block diagram of an example of a computing system 200 capable of implementing the PNG constructive method 100 shown in FIG. 1, according to some arrangements. The computing system 200 is a computing system having processing, storage, and networking capabilities for generating, communicating, and/or using the random prime number in computer cryptography. Examples of the computing system 200 include one or more servers, one or more cloud-based computing devices, and so on.

The computing system 200 is shown to include various circuits and logic for implementing the operations described herein. More particularly, the computing system 200 includes at least a processing circuit 212, a network interface circuit 218, a cryptography circuit 220, an application circuit 222, and so on. While various circuits, interfaces, and logic with particular functionality are shown, it should be understood that the computing system 200 includes any number of circuits, interfaces, and logic for facilitating the operations described herein. For example, the activities of multiple circuits are combined as a single circuit and implemented on a same processing circuit (e.g., the processing circuit 212), as additional circuits with additional functionality are included.

In some arrangements, the processing circuit 212 includes a processor 214 and a memory 216. The processor 214 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 216 (e.g., Random Access Memory (RAM), Read-Only Memory (ROM), Non-Volatile RAM (NVRAM), Flash Memory, hard disk storage, etc.) stores data and/or computer code for facilitating the various processes described herein. Moreover, the memory 216 is or includes tangible, non-transient volatile memory or non-volatile memory. Accordingly, the memory 216 includes database components, object code components, script components, or any other type of information structure for supporting the various activities and information structures described herein. The processing circuit 212 can be used to implemented one or more of the circuits 218, 220, and 222.

The application circuit 222 can be used to execute one or more applications or software on the computing system 200 for which data, information, messages, and so on may need to be encrypted and/or decrypted using an encryption key (e.g., a symmetric key, an asymmetric key, and so on). For example, the application circuit 222 can execute a mobile banking application, a browser, a mobile banking application, a mobile wallet, an email application, a messaging application, and so on, for which data, information, messages, and so on need to be encrypted or decrypted. The application circuit 222 can send encrypted data, information, messages, and so on to another device using the network interface circuit 218 via a network or receive encrypted data, information, messages, and so on from another device using the network interface circuit 218.

The cryptography circuit 220 is executed by the processing circuit 212 in some arrangements. The cryptography circuit 220 can perform cryptographic operations such as generating the random prime number 135 according to the method 100. The computing system 200 can provide the cryptography circuit 220 in various manners. In some arrangements, the cryptography circuit 220 is a server-based application executable on the computing system 200. In this regard, the user of the computing system 200 has to download the cryptography circuit 220 from an application download server prior to usage. In some arrangements, the cryptography circuit 220 is a web-based interface application provided by an application server. In some arrangements, the cryptography circuit 220 includes an Application Programming Interface (API) and/or a Software Development Kit (SDK) provided by the application server that facilitates integration with other applications (e.g., the application circuit 222). In some arrangements, the cryptography circuit 220 is coded into the memory 216 of the computing system 200. In some arrangements, the cryptography circuit 220 is provided on a separate hardware with software and/or firmware operating the hardware, where the cryptography circuit 220 can be physically connected to the rest of the computing system 200 using a physical connection or a wired connection. All such variations and combinations are intended to fall within the spirit and scope of the present disclosure.

The cryptography circuit 220 includes the QRNG 110 and the PNG algorithm 120 (e.g., a PNG). The QRNG 110 (e.g., the quantum entropy 112 having quantum entropy sources) can generate a stream of quantum entangled particles, such as photons containing information such as a string of binary zeroes and ones to be measured by the entropy measure function 114 to generate random bits. The RNG 116 generates sufficient random bits, such as the initial RNG input 120 and the secondary RNG input 125. For example, the QRNG 110 can include a QKD device as the quantum entropy source providing the quantum entropy 112. The PNG algorithm 120 can generate the random prime number 135 using the initial RNG input 120 and the secondary RNG input 125 as described.

The network interface circuit 218 is configured for and structured to establish a connection and communicate with another device via a network. The network interface circuit 218 is structured for sending and receiving data over a communication network or a physical connection (e.g., via a physical connector such as Universal Serial Bus (USB)). Accordingly, the network interface circuit 218 includes any of a cellular transceiver (for cellular standards), wireless network transceiver (for 802.11X, ZigBee, Bluetooth, Wi-Fi, or the like), wired network interface, or a combination thereof. For example, the network interface circuit 218 may include wireless or wired network modems, ports, baseband processors, and associated software and firmware.

The network is any suitable Local Area Network (LAN), Wide Area Network (WAN), or a combination thereof. For example, the network 130 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The network is structured to permit the exchange of data, values, instructions, messages, and the like.

In some examples, the computing system 200 can be a Hardware Security Module (HSM) which includes the cryptography circuit 220 to generate the random prime number 135 in the manner described. In such examples, the cryptography circuit 220 can use the random prime number 135 as, input into a KDF to generate a symmetric key, or input into a KGF to generate an asymmetric key.

In some examples, the computing system 200 can send, via a network using the network interface circuit 218, the random prime number 135 generated in the manner described herein to a receiving system, such as an HSM or to an application using a cryptographic library. In such examples, the computing system 200 is an external system that can be offered as a service, such as a cloud-based services or possibly a separate network appliance, providing independent quantum-based random prime numbers to an HSM. The computing system 200 can pass the random prime number 135 to the receiving system (e.g., the HSM), which can use the random prime number 135, input into a KDF to generate a symmetric key, or input into a KGF to generate an asymmetric key. According, in such examples, the application circuit 222 which uses a key generated based on the random prime number resides in the receiving device.

FIG. 3 is a flowchart diagram illustrating an example method 300 for constructing a random prime number, according to some arrangements. The method 300 can be performed using the computing system 200 in some examples. The method 100 can be an example of the method 300.

At 310, the QRNG 110 generates an initial random number (e.g., the initial RNG input 120) and a secondary random number (e.g., the secondary RNG input 125). In some examples, the quantum entropy 112 can include first quantum entropy and second quantum entropy from one or more quantum entropy sources. The first quantum entropy from the one or more quantum entropy sources can be measured by the QRNG (e.g., the entropy measure function 114). The initial random number is generated based on the first quantum entropy by interpreting, by the entropy measure function 114, the first quantum entropy into first random bits. The first quantum entropy corresponds to first quantum particles or a first stream of photons. In some examples, the second quantum entropy from the one or more quantum entropy sources can be measured by the QRNG (e.g., the entropy measure function 114). The secondary RNG input is generated based on the second quantum entropy by interpreting, by the entropy measure function 114, the second quantum entropy into second random bits. The second quantum entropy corresponds to second quantum particles or a second stream of photons.

At 320, the PGN (e.g., the PGN algorithm 120) generates the random prime number 135 using the initial random number and the secondary random number. In some examples, the random prime number is generated using a constructive method for generating guaranteed prime numbers. The constructive method includes at least one of Shawe-Taylor's Algorithm or Maurer's Algorithm. The PGN algorithm 120 generates the random prime number by running a PNG algorithm recursively to generate the random prime number. In some arrangements, a random prime number generated using a constructive method is guaranteed to be prime and does not require prime testing by another algorithm.

In some examples, Shawe-Taylor's Algorithm is a recursive algorithm. In Shawe-Taylor's Algorithm, the initial RNG input 120 (e.g., x) is randomly generated, using the QRNG 110. A first secondary input a (e.g., the secondary RNG input 125) is generated by the QRNG 110. The following expression is computed:

$$x = {a}^{2 t} mod y , \qquad ( 1 )$$

where x does not equal to 1. If GCD(x−1, y)=1 and x^{q}≡1 (mod y), then y is the random prime number 135. Otherwise, t=t+1, and expression (1) is recursively re-computed, hence the algorithm is recursive.

In some examples, Maurer's Algorithm is a recursive algorithm. In Maurer's Algorithm, the initial RNG input 120 (e.g., R) is randomly generated, using the QRNG 110. A parameter n is generated using R. In response to determining that n is not divisible by a prime number less than a threshold (e.g., B), another random number a (e.g., the secondary RNG input 125) is set, and expression below is computed:

$$e = {a}^{n - 1} , \qquad ( 2 )$$

where if e equals to 1, then e=a^{2R} mod n, and d=GCD(e−1,n). In response to determining that d equals to 1, then the parameter n is the random prime number 135. Otherwise, the process returns to selection of the initial RNG input 120 (e.g., R), based on which the parameter n is generated. Hence the algorithm is recursive.

At 330, the cryptography circuit 220 can generate an encryption key using the random prime number. The encryption key is used to encrypt first data or decrypt second data. In some examples, the random prime number 135 can be inputted into a KDF to generate a symmetric key or input into a KGF to generate an asymmetric key. In some examples, the cryptography circuit 220 can encrypt the first data and/or decrypt the second data for an application running on the application circuit 222. In some examples, the network interface circuit 218 can send encrypted data encrypted using the encryption key via the network to another device. In some examples, the network interface circuit 218 can receive encrypted data to be decrypted using the encryption key via the network from another device. In some examples, the network interface circuit 218 can send the encryption key to another device, which can encrypt the first data or decrypt the second data.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method, comprising:
generating, using a Quantum Random Number Generator (QRNG), an initial random number and a secondary random number;
generating, using a Prime Number Generator (PGN), a random prime number using the initial random number and the secondary random number; and
generating an encryption key using the random prime number, wherein the encryption key is used to encrypt first data or decrypt second data.

2. The method of claim 1, comprising:
measuring, by the QRNG, first quantum entropy from a quantum entropy source; and
generating the initial random number based on the first quantum entropy by interpreting the first quantum entropy into first random bits.

3. The method of claim 2, wherein the first quantum entropy corresponds to first quantum particles or a first stream of photons.

4. The method of claim 1, comprising:
measuring, by the QRNG, second quantum entropy from a quantum entropy source; and
generating the secondary random number based on the second quantum entropy by interpreting the second quantum entropy into second random bits.

5. The method of claim 4, wherein the second quantum entropy corresponds to second quantum particles or a second stream of photons.

6. The method of claim 1, wherein the random prime number is generated using a constructive method for generating guaranteed prime numbers.

7. The method of claim 6, wherein the constructive method comprises Shawe-Taylor's Algorithm.

8. The method of claim 6, wherein the constructive method comprises Maurer's Algorithm.

9. The method of claim 1, wherein generating, using the PGN, the random prime number comprises running a PNG algorithm recursively to generate the random prime number.

10. A system, comprising:
a memory; and
a processor configured to:
generate, using a Quantum Random Number Generator (QRNG), an initial random number and a secondary random number;
generate, using a Prime Number Generator (PGN), a random prime number using the initial random number and the secondary random number; and
generate an encryption key using the random prime number.

11. The system of claim 1, the processor configured to:
measure, using the QRNG, first quantum entropy from a quantum entropy source; and
generate the initial random number based on the first quantum entropy by interpreting the first quantum entropy into first random bits.

12. The system of claim 11, wherein the first quantum entropy corresponds to first quantum particles or a first stream of photons.

13. The system of claim 10, the processor configured to:
measure, using the QRNG, second quantum entropy from a quantum entropy source; and
generate the secondary random number based on the second quantum entropy by interpreting the second quantum entropy into second random bits.

14. The system of claim 13, wherein the second quantum entropy corresponds to second quantum particles or a second stream of photons.

15. The system of claim 10, wherein the random prime number is generated using a constructive method for generating guaranteed prime numbers.

16. The system of claim 15, wherein the constructive method comprises Shawe-Taylor's Algorithm.

17. The system of claim 15, wherein the constructive method comprises Maurer's Algorithm.

18. The system of claim 10, wherein generating, using the PGN, the random prime number comprises running a PNG algorithm recursively to generate the random prime number.

19. A non-transitory processor-readable medium comprising processor-readable instructions, such that, when executed, causes a processor to:
generate, using a Quantum Random Number Generator (QRNG), an initial random number and a secondary random number;
generate, using a Prime Number Generator (PGN), a random prime number using the initial random number and the secondary random number; and
generate an encryption key using the random prime number.

20. The non-transitory processor-readable medium of claim 19, the processor is caused to:
measure, using the QRNG, first quantum entropy from a quantum entropy source; and
generate the initial random number based on the first quantum entropy by interpreting the first quantum entropy into first random bits, the first quantum entropy corresponds to first quantum particles or a first stream of photons;
measure, using the QRNG, second quantum entropy from a quantum entropy source; and
generate the secondary random number based on the second quantum entropy by interpreting the second quantum entropy into second random bits, wherein the second quantum entropy corresponds to second quantum particles or a second stream of photons.
